(19) United States
(12) Patent Application Publication
(10) Pub. No.: US 2007/0025217 A1
(43) Pub. Date: Feb. 1, 2007

(54) Method and apparatus for detecting phase error information in multilevel recording/reproduction system

(75) Inventors: Yasuyuki Miyaoka, Yokohama-shi (JP); Masakuni Yamamoto, Yamato-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/486,110

(22) Filed: Jul. 14, 2006

(30) Foreign Application Priority Data
Jul. 26, 2005 (JP) 2005-216226

(51) Int. Cl. G11B 27/36

(52) U.S. Cl. 369/53.34

(57) ABSTRACT

An optical information reproduction method includes the steps of detecting, in at least two adjacent virtual cells provided in a recording/reproduction area of an optical information medium, at least two cell center signal levels and a cell boundary signal level between the cell center signal levels and acquiring phase error information of a reproduction signal based on a difference between the detected cell boundary signal level and an ideal cell boundary signal level obtained in advance and on a gradient of reproduction signal levels corresponding to the detected cell center signal levels.

### BACKGROUND OF THE INVENTION

1. Field of the Invention

The present invention relates to optical information recording/reproduction methods and apparatuses for recording/reproducing multilevel information, in which recording or reproduction is performed using three or more value levels of information pits or marks. In particular, the present invention relates to a method of detecting phase error information for generating a reproduction clock used in reproducing recorded information.

2. Description of the Related Art

Recent years have seen the expansion of the optical memory industry. Various types of optical memories have been developed, including read-only CDs and DVDs, a write once memory which uses a metal film or a dye-based recording material, and further, a rewritable memory using an optical magnetic material or a phase change material. Implementations of these memories have also been expanded from public-oriented applications to external memory applications for computers.

Research and development has been promoted with a view to increasing recording density. As a technique for minimizing the size of a light spot used for information recording/reproduction, a violet wavelength (405 nm) of a light source has been employed more than a red wavelength (650 nm). In addition, an attempt has been made to increase the numerical aperture (NA) of an objective lens from 0.6 or 0.65 to 0.85. On the other hand, a technique of multilevel recording/reproduction has been proposed for achieving more efficient recording/reproduction using an identical size of light spots.

For example, Japanese Patent Laid-Open No. 5-128530 describes, as a multilevel recording/reproduction technique, a method for recording multilevel information on an information track of an optical information recording medium, using a combination of the length of an information pit in the track direction and the amount of shift of the information pit in the track direction with respect to a reproduction light spot. Japanese Patent Laid-Open No. 5-128530 also describes a reproduction method for reproducing the above multilevel recorded information pit using correlation between a detection signal which has been learned and a detection signal which is obtained from the light spot.

In addition, in “ISOM 2003, Write-once Disks for Multi-level Optical Recording, Draft Collection, Fr-Po-04”, published by ISOM which is an international symposium in the field of optical disc research, an experiment report is presented. In this report, eight-level recording/reproduction is performed, using an optical system with a violet light source of 405 nm wavelength and an NA of 0.65, on an optical disc with a track pitch of 0.46 μm provided with a virtual region for recording one information pit (hereinafter referred to as a cell) whose width in the track direction is set to be 0.26 μm.

Setting of the eight-level information pits is performed, for example, by dividing the length of a cell in the track direction shown in FIG. 14 into sixteen (16-channel bits) and setting the level of an information pit as follows: level 0: no information pit to be recorded; level 1: having a width of 2 channel bits; level 2: having a width of 4 channel bits; level 3: having a width of 6 channel bits; level 4: having a width of 8 channel bits; level 5: having a width of 10 channel bits; level 6: having a width of 12 channel bits; and level 7: having a width of 14 channel bits.

The information pits set as described above are randomly recorded, and an amount of light reflected from each information pit is received by a photodetector. Then, a timing of a reproduction signal for sampling from the information pits is set to a point when the center of a light spot is irradiated on the center of a cell with respect to the track direction. This results in a distribution of amplitudes of the reproduction signal which correspond to the individual levels, as shown in FIG. 15.

In this case, a clock used for sampling information is configured to be generated through a phase-locked loop circuit (a PLL circuit) after phase error information is detected by reproduction of a predetermined pattern inserted in recording information at predetermined intervals.

Referring to FIG. 16, an example of pattern insertion for phase error detection is illustrated. The figure illustrates recording information strings, including a PLL pull-in pattern 16a, a learning pattern 16b, user information strings 16c, 16e, 16g, and 16i, and phase error detection patterns 16d, 16f, and 16h. The PLL pull-in pattern 16a is located at the head of recording data and is applied in many circumstances regardless of whether or not multilevel recording is performed. The learning pattern 16b is a recording pattern used for learning for obtaining a reproduction signal of a given pattern which will be described below. In the user information strings 16c, 16e, and 16g, user information to be recorded is generated after undergoing processing such as error correction. The phase error detection patterns 16d, 16f, and 16h are recording patterns used for phase error detection of a reproduction clock. For example, an edge is extracted through binarization processing by level slicing, and phase error information between the extracted edge and a reproduction clock is detected using a phase comparator. The detected phase error information is used for PLL processing performed on the reproduction clock. Since in multilevel recording, edge cycles are constant regardless of the size of each recording mark, in order to obtain phase information with a good S/N ratio, it is desirable to employ patterns for phase error detection arranged such that the lowest level and the highest level are alternately obtained.

Referring back to FIG. 15, as a standardized configuration, the reproduction signal level when there are consecutive information pits of level 0, i.e., there are no written information pits, is set as “1”, and the reproduction signal level when information pits of level 7 are consecutively recorded is set as “0”.

The values of the reproduction signal level corresponding to the individual information pit levels have a range since a target information pit is affected by information pits written in the preceding and succeeding cells (inter-symbol interference). When an amplitude distribution of the reproduction signal at a certain level is overlapped with that of the reproduction signal at an adjacent level, a fixed threshold value cannot be used for discriminative detection of signal levels.

In the example of the ISOM 2003 report, a technique of discriminative detection of signal levels is discussed with a view to solving this problem. In this technique, a reproduction signal is read from a mark string in which the level of a target information pit and the levels of the preceding and succeeding information pits are given in advance, and then, the read signal is stored (learning). Then, an actual reproduction signal from the information pits is compared with the stored read signal (correlating). The recording density which can be applied in this technique is 16 Gbit/inch².

However, for implementation of the multilevel information recording/reproduction described above, it is necessary to insert a mark string which is sufficiently large to detect phase information in the generation of a reproduction clock for detecting reproduction signal levels. Such a large mark string is necessary for phase information detection using a predetermined interval and a predetermined length for obtaining a phase error signal with high precision and, for example, through binarization processing using a fixed slice level.

This insertion of a mark string for phase error detection has a disadvantage in that it is performed at the expense of an increase in linear density and it reduces the information efficiency of a recording format.

### SUMMARY OF THE INVENTION

The present invention has been made in view of the above circumstance. Accordingly, there is a need for a multilevel information reproduction method for detecting phase error information from a recording information reproduction signal so as to generate a reproduction clock, without inserting a recording pattern specifically serving for phase error detection. Specifically, an optical information reproduction method can be provided in which virtual cells are provided at regular intervals on an optical information medium and in which multilevel information is reproduced from the optical information medium having a recording/reproduction area for, using a light spot, recording multilevel information by changing widths in the track direction or sizes of information pits in the virtual cells, and reproducing multilevel information by detecting from the information pits multiple levels of a reproduction signal. This optical information reproduction method includes the steps of detecting, in at least two adjacent virtual cells in the recording/reproduction area, at least two cell center signal levels and a cell boundary signal level between the cell center signal levels and acquiring phase error information of the reproduction signal on the basis of a difference between the detected cell boundary signal level and an ideal cell boundary signal level obtained in advance and of a gradient of reproduction signal levels corresponding to the detected cell center signal levels.

Further, an optical information recording/reproduction apparatus can be provided to include an information recording circuit for, using a light spot, recording multilevel information on virtual cells provided at regular intervals on an optical information medium having a recording/reproduction area by changing widths in a track direction or sizes of information pits and an information reproduction circuit for reproducing multilevel information by detecting multiple levels of a reproduction signal from the information pits recorded on the optical information medium. The information reproduction circuit detects, in at least two adjacent virtual cells, at least two cell center signal levels and a cell boundary signal level between the cell center signal levels, and acquires phase error information of the reproduction signal based on a difference between the detected cell boundary signal level and an ideal cell boundary signal level corresponding to the detected cell center signal levels and on a gradient of reproduction signal levels in the vicinity of the ideal cell boundary signal level.

Further features of the present invention will become apparent from the following description of exemplary embodiments with reference to the attached drawings.

### BRIEF DESCRIPTION OF THE DRAWINGS

FIG. 1 is a block diagram illustrating an optical information recording/reproduction apparatus according to an exemplary embodiment of the present invention.

FIG. 2 illustrates widths of multilevel information pits in the track direction which are associated with levels of the multilevel information pits and illustrates combination patterns of three bits corresponding to the pit levels.

FIG. 3 is a schematic diagram illustrating a relationship between a light spot and information pits recorded randomly on a track.

FIG. 4 illustrates parameters used in an optical simulation according to an exemplary embodiment of the present invention.

FIG. 5 illustrates a shape of an information pit employed in an optical simulation according to an exemplary embodiment of the present invention.

FIG. 6 shows a result of an optical simulation according to an exemplary embodiment of the present invention and illustrates reproduction signal levels corresponding to combination patterns of information pits written in three consecutive cells.

FIG. 7 shows an amplitude distribution of cell center signal levels according to optical parameters of an optical information recording/reproduction apparatus according to an exemplary embodiment of the present invention.

FIG. 8A illustrates an amplitude distribution of cell boundary signal levels according to optical parameters of an optical information recording/reproduction apparatus according to an exemplary embodiment of the present invention.

FIG. 8B shows combination patterns of information pits written in two adjacent cells.

FIG. 9 illustrates a relationship between a light spot and two adjacent cells when a cell boundary signal level is sampled.

FIG. 10 shows a change in a reproduction signal level which illustrates a phase error detection method according to an exemplary embodiment of the present invention.

FIG. 11 illustrates a recording information string according to an exemplary embodiment of the present invention.

FIG. 12 is a flowchart illustrating information recording performed by an optical information recording/reproduction apparatus according to an exemplary embodiment of the present invention.

FIG. 13 is a flowchart illustrating information reproduction performed by an optical information recording/reproduction apparatus according to an exemplary embodiment of the present invention.

FIG. 14 illustrates widths of multilevel information pits associated with levels of the multilevel information pits according to a known technique.

FIG. 15 illustrates an amplitude distribution of cell center signal levels.

FIG. 16 illustrates a recording information string according to a known technique.

### DESCRIPTION OF THE EMBODIMENTS

In the following, the preferred exemplary embodiments of the present invention will be described in detail with reference to the accompanying drawings.

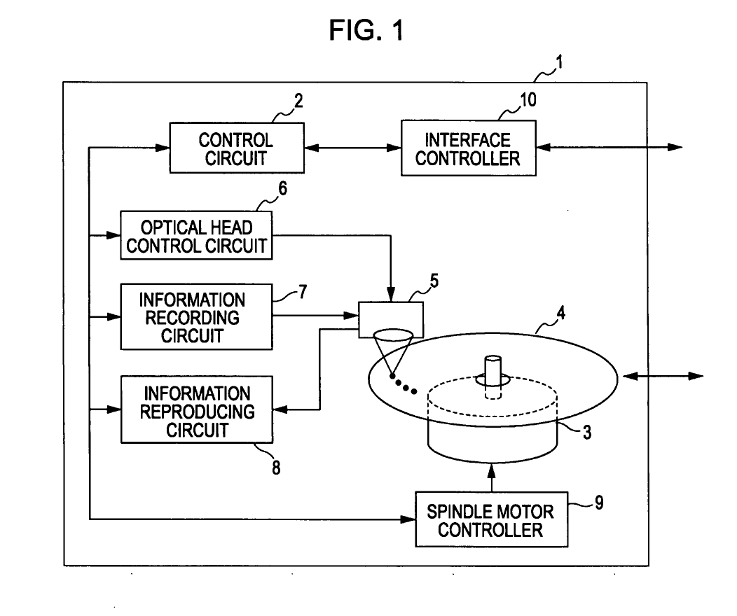

FIG. 1 is a block diagram illustrating a configuration of an optical information recording/reproduction apparatus according to an exemplary embodiment of the present invention.

An optical information recording/reproduction apparatus 1 has a control circuit 2, a spindle motor 3, an optical disc 4, an optical head 5, an optical head control circuit 6, an information recording circuit 7, an information reproduction circuit 8, a spindle motor controller 9, and an interface controller 10.

The control circuit 2 controls sending/receiving of information to and from an information processing device such as an external computer and controls recording or reproduction of information on the optical disc 4 using the information recording circuit 7 and the information reproduction circuit 8. The control circuit 2 also controls other operation units. The information recording circuit 7 performs recording of multilevel information, and the information reproduction circuit 8 performs reproduction of multilevel information, which will be hereinafter described.

The spindle motor 3 is controlled by the spindle motor controller 9 and drives rotation of the optical disc 4. The optical disc 4 is an optical information recording medium which is inserted into or ejected from the optical information recording/reproduction apparatus 1 by means of a mechanism not shown in the figure.

The optical head 5 serves to optically record information on and reproduce information from the optical disc 4. In the optical head 5, for example, when a light source with a wavelength of 405 nm and an objective lens with an NA of 0.85 are provided, a light spot of 0.405 μm is obtained. The size of the track pitch of the optical disc 4 is 0.32 μm in this example. The optical head control circuit 6 serves to control a position of a light spot using the optical head 5 and performs automatic tracking control, seek operation control, and automatic focusing control.

The generation of phase error information in information reproduction according to an exemplary embodiment of the present invention is carried out by the information reproduction circuit 8.

Now, a method and an apparatus for multilevel information recording will be described.

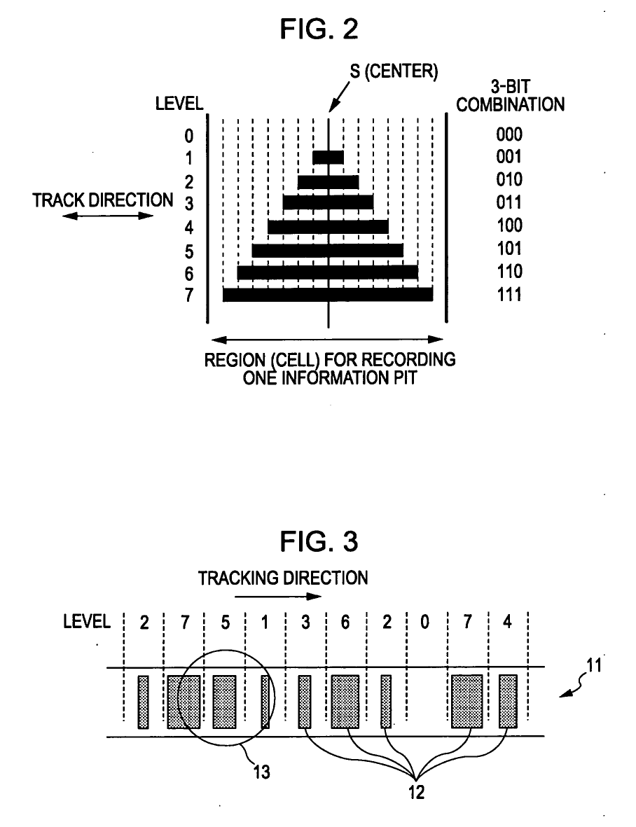

FIG. 2 illustrates widths or multilevel information pits in the track direction shown in the figure used in the optical information recording/reproduction apparatus 1 according to an exemplary embodiment of the present invention. The widths are associated with differences in the levels of the multilevel information pits. For simplifying the description, the widths of these information pits in the direction perpendicular to the track direction is shown as being smaller than the actual relative widths.

In this figure, the region sandwiched by two thick solid lines represents a cell in which an information pit or mark is written. In this exemplary embodiment, since the size of a light spot is approximately 0.405 μm, and the track pitch of the optical disc 4 is 0.32 μm, when the width of the cell is set to 0.2 μm, an a real density of 30 Gbit/inch² can be achieved. The description will be continued on the basis of this cell width of 0.2 μn.

In this case, the width of the smallest information pit (level 1) is 25 nm, and the sizes of the other information pits are as follows: 50 nm (level 2), 75 nm (level 3), 100 nm (level 4), 125 nm (level 5), 150 nm (level 6), 175 nm (level 7). The level 0 is indicative of no information pit for recording.

In the multilevel recording in this exemplary embodiment, eight-level recording is employed. Thus, three bits can be recorded in one cell. As shown in FIG. 2, in 3-bit information, 0,0,0 corresponds to level 0; 0,0,1 corresponds to level 1; 0,1,0 corresponds to level 2; 0,1,1 corresponds to level 3; 1,0,0 corresponds to level 4; 1,0,1 corresponds to level 5; 1,1,0 corresponds to level 6; and 1,1,1 corresponds to level 7. Obviously, other correspondence schemes can be employed.

FIG. 3 is a schematic diagram illustrating a case where information pits 12 are randomly recorded on a track 11 provided on the optical disc 4. This figure also illustrates a relationship between these elements and a light spot 13. For example, when a phase change material is used as an erasable recording material, the light spot 13 is irradiated onto the optical disc 4, and the light intensity and timing of each of a recording pulse, an erasing pulse, and a cooling pulse are adjusted. This causes the shape of the information pits 12 to be changed, resulting in the formation of information pits with a plurality of levels. In FIG. 3, for convenience, these information pits 12 are shown as rectangular information pits, and a state is shown where the width of each information pit in the track direction is changed. However, these information pits are not restricted to having a rectangular shape in this exemplary embodiment. Even when information pits with a circular shape, an oval shape, or a sagittate shape are applied, the essence of the present proposal will not be changed as long as these information pits correspond to the sizes associated with the individual levels.

In addition, for the erasable recording material, a magneto-optic recording material can be employed as well as a phase change material. In this case, in the optical information recording/reproduction apparatus 1, information pits having multiple reproduction levels are formed by changing the shapes of the information pits, using not only a light spot but also by a cooperative operation of the light spot and a magnetic field applied from a magnetic head (not shown).

Further, a write once recording material can be applied such as an organic dye material and a metal film. In this case, a light spot is irradiated onto an optical disc, and the shapes of information pits are changed by adjusting the recording light intensity and the timing of irradiation, so that information pits having a plurality of reproduction levels are formed. In addition, on a read-only recording medium, information pits called phase pits having lands and recesses can similarly be formed on a substrate. Multilevel recording can be achieved by modulating the sizes or the optical depths of these phase pits.

In order to increase recording capacity, it is necessary to reduce the size of a cell. When the cell size is reduced, as shown in FIG. 3, information pits written in two or three cells are present within the range of the optical spot 13. The description of the present exemplary embodiment will be continued on the basis of such multilevel recording using an exemplary case where a phase change material is employed.

In FIG. 3, the track direction is indicated by the arrow, and the track 11 is provided on the optical disc 4 for recording the information pits 12. Regions separated by broken lines are virtual cells (each hereinafter referred to as a cell). In the individual cells, each of the information pits 12, which correspond to the levels determined according to the arrangement shown in FIG. 2, are recorded. The levels of the information pits are indicated in the upper part of FIG. 3. The circle shown in the figure is the light spot 13.

In this exemplary embodiment, the size of the light spot 13 is approximately 0.405 μm and the size of each of the cells is 0.2 μm. In this scale, an a real density is obtained which is about 1.5 times higher than that obtained with a known two-level technique (for example, an a real density of 19.5 Gbit/inch² obtained where 2T=139 nm, in 1-7PP modulation).

In the following, a result obtained from an optical simulation of a reproduction signal according to this exemplary embodiment is described.

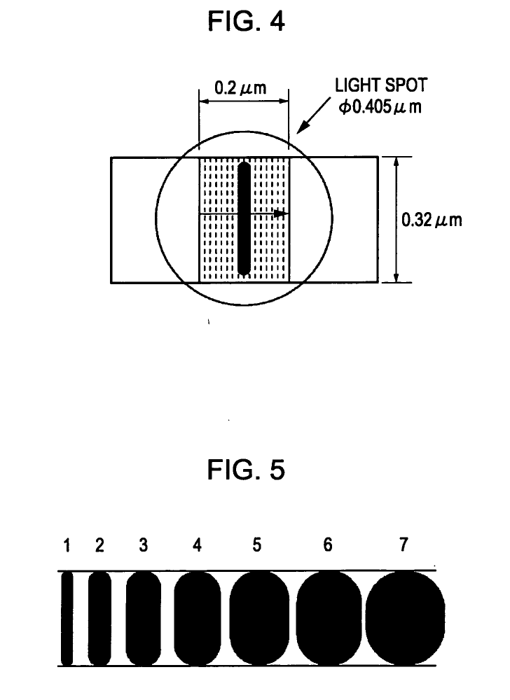

Referring to FIG. 4, parameters used for this optical simulation are as follows: a 0.32 μm track pitch, a 0.405 μm light spot size (wavelength; 405 μm, objective lens NA; 0.85), a 0.2 μm cell size. The shape given to the information pits 12 is assumed to be that shown in FIG. 2, and the shapes corresponding to the individual levels are given as shown in FIG. 5.

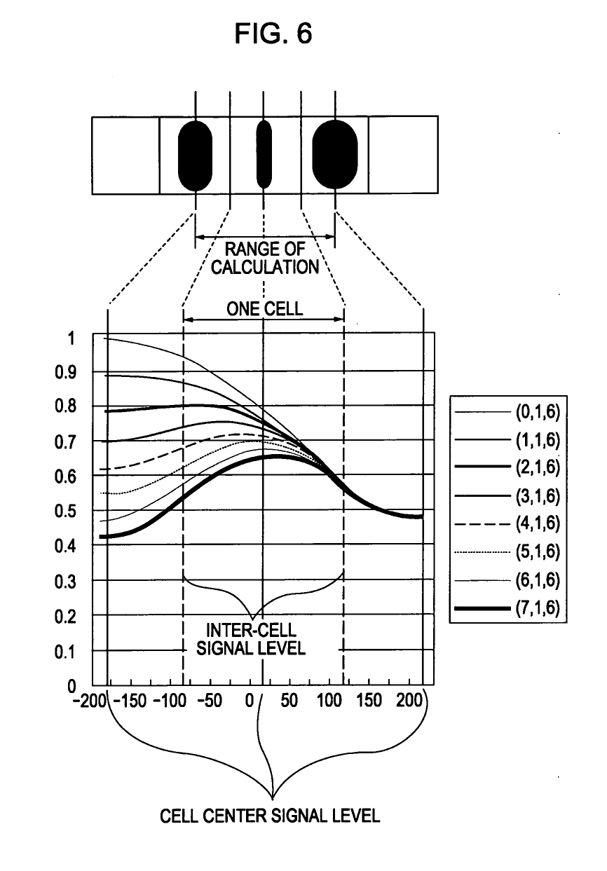

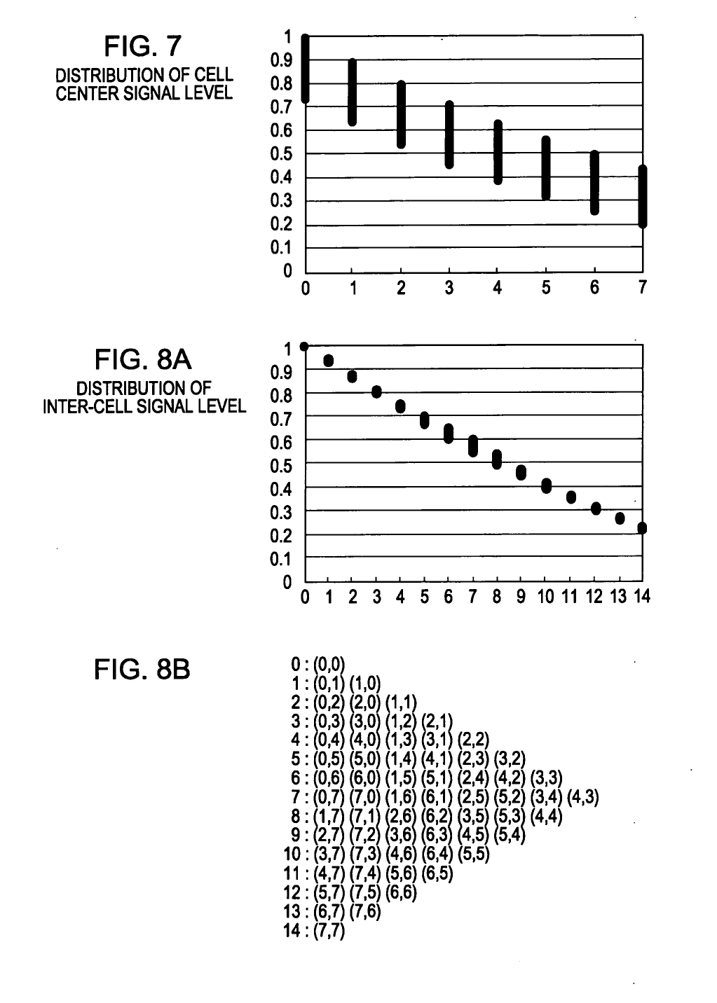

As shown in FIG. 6, combinations of the eight pit levels are sequentially given for three consecutive cells (all pit level combination patterns are obtained as 8×8 ×8=512), of which the cell on the left side in the figure is referred to as a first cell, the cell in the center, as a second cell, and the cell on the right side, as a third cell. Levels of a reproduction signal (reflected light intensity) obtained where the light spot 13 is moved from the center of the first cell to the center of the third cell were calculated.

For illustrative purposes, FIG. 6 shows eight combination patterns of the pit levels of the cells from (0,1,6) to (7,1,6). Note that the pit level of any cell other than the first to third cells is assumed to be 0.

In the figure, the position of each of three solid lines indicates a reproduction signal level obtained when the light spot 13 is located at the center of each cell (cell center signal level), and the position of each of two broken lines indicates a reproduction signal level obtained when the light spot 13 is located at a boundary between the cells (cell boundary signal level).

When looking at the values of reproduction signals corresponding to the pit level combination pattern at the boundaries of adjacent cells (i.e., cell boundary signal levels), it can be found that all of the eight pit level combination patterns have approximately the same cell boundary signal levels at the boundary between the second cell and the third cell. More specifically, if in all pit level combination patterns, each of two adjacent cells has the same pit levels (“1” and “6”, for the second and third cells, respectively, in this case), the obtained cell boundary signal level is not significantly affected by the pit level of the cell on the other side (the first cell, in this case), indicating that the effect of inter-symbol interference is very small.

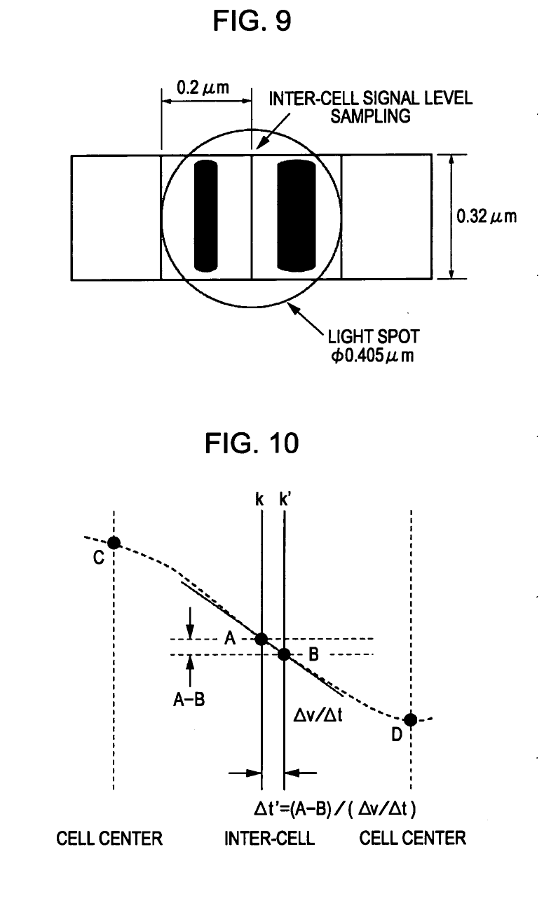

FIG. 9 illustrates a positional relationship obtained when the light spot 13 is irradiated at the boundary of two adjacent cells. The size of the light spot 13 is 0.405 μm and the width of the two cells is 0.4 μm, and therefore most of the light spot 13 is located on the two cells. Thus, it is intuitively found that there is little influence from other cells.

FIG. 8A illustrates an amplitude distribution of the cell boundary signal levels of a reproduction signal with respect to combinations of pit levels of two adjacent cells (all combination patterns are obtained as 8×8=64). Note that an amplitude distribution is standardized to be determined using the reflectivities of a pit region and a non-pit region. In the figure, the abscissa indicates the sum of the pit levels of two adjacent cells. Specifically, 15 values can be obtained according to the pit level combinations of the two adjacent cells: value 0 (0,0) to value 14 (7,7).

It can be found that these 15 values (value 0 to value 14) can be obtained without signal processing such as waveform equalization. The pit level combination patterns of the two adjacent cells corresponding to the 15 values are shown in FIG. 8B.

Now, a phenomenon according to a principle of the present invention will be described on the basis of a characteristic of the reproduction signal described above.

Referring back to FIG. 6, when looking at the change in signal level between the cell center signal level, cell boundary signal level, and cell center signal level of the second and third cells, in addition to the very small variance of the signal level in the cell boundary signal level, it can be found that the gradient of signal level change in the vicinity of the cell boundary signal level is approximately constant in every pit level combination pattern.

Thus, it can be found that from this phenomenon that the cell boundary signal level in an ideal state can be inferred where the pit levels of two adjacent cells corresponding to cell center signal levels having the cell boundary signal level therebetween are determined. At the same time, the gradient of a reproduction signal around the boundary of the two adjacent cells (i.e., in the vicinity of the cell boundary signal level) can be inferred. According to this exemplary embodiment, phase error information can be obtained from a reproduction signal using the phenomenon described above. In addition, since it is necessary in this exemplary embodiment to sample both a cell center signal level and a cell boundary signal level, a reproduction clock has to have a rate which is more than two times higher than the cell frequency.

Further description will be given with reference to FIG. 10. This figure illustrates a state of cell center signal levels using an example of the pit level combination pattern (1,6) of the second and third cells. The cell center signal levels in this case are indicated as C and D corresponding to the second and third cell, respectively. A time k indicates a reproduction signal sampling state at a cell boundary time in an ideal state. The cell boundary signal level obtained at the time k is indicated as A. Now, taking into account PLL control for obtaining the reproduction clock, detection of phase error information of the cell boundary signal level is attempted. When a case is assumed where a reproduction signal sampling clock is phase-shifted to a position k′, the detected cell boundary signal level B is obtained. In this condition, if the cell center signal levels are given, i.e., C, D, in this case, the ideal relationship between the cell center signal level, cell boundary signal level, and cell center signal level can be indicated as C, A, D, shown in FIG. 10. Thus, the ideal cell boundary signal level and the reproduction signal level gradient in the vicinity of the cell boundary signal level are also given. Therefore, using these three elements, i.e., (1) ideal reproduction signal level gradient in the vicinity of the cell boundary signal level (Δv/Δt), (2) ideal cell boundary signal level A, and (3) cell boundary signal level of an actual reproduction signal B, a phase error state of the sampling clock Δt′can be calculated as: Δt′=(A−B)/(Δv/Δt).

The above ideal states (1) and (2) need not only be those obtained from a simulation or the like, but also be reproduction signal levels obtained from a learning area of a given recording string provided at the head of a user information string. Rather, the latter can be more desirable than the former in that it brings about a state in which various influential factors such as recording conditions are reflected. In the following, a description will be provided in regard to a calculation of a reproduction signal level gradient around the boundary of adjacent cells (in the vicinity of a cell boundary signal level) and a calculation of phase error when learning data is used.

For the calculation of a reproduction signal level gradient in the vicinity of a cell boundary signal level, cell center signal levels of two adjacent cells of learning data are linear-approximated so that the gradient in the vicinity of the cell boundary signal level is calculated. This process is used as the simplest example. When reproduction is in progress, level determination of information pit levels is performed, and using the determined levels, corresponding cell center signal levels, the gradient of these two cell center signal levels (Δv/Δt), and corresponding cell boundary signal level A obtained from learning are extracted. Then, in comparison with an actual cell boundary signal level B obtained during reproduction, a time shift of the sampling time, i.e., a phase error signal, is detected.

Further, a scheme can be applied in which, in the learning data, curve fitting is performed using three values: the cell center signal levels of two adjacent cells and the cell boundary signal level A between the cell center signal levels, and then, the gradient in the vicinity of the cell boundary signal level (Δv/Δt) is calculated using the gradient of the tangent to the cell boundary signal level A. Alternatively, the fitted curve itself can be applied as a gradient curve. With this arrangement, from the difference between the cell boundary signal level A obtained from learning and the cell boundary signal level B obtained during reproduction, a phase error signal can also be calculated with high precision.

Still further, four cell center signal values used for the gradient calculation can be used for a gradient calculation. Specifically, the signal level at the boundary between each of two adjacent cells can be applied as the cell boundary signal levels used for phase error calculation. This enables further higher precision of the gradient calculation at a cell boundary signal level time.

As described above, on the basis of level information of cell center signal levels and a cell boundary signal level which are obtained from a learning process, a reproduction signal level gradient in the vicinity of the cell boundary signal level (Δv/Δt) is calculated. Then, this gradient (Δv/Δt) and the ideal cell boundary signal level A are applied to the cell boundary signal level B obtained from an actual reproduction signal. This allows a phase error signal to be extracted directly from a reproduction signal in reproduction of recorded multilevel information.

In a case where there is no or a small difference between the pit levels of two adjacent cells, a very small reproduction signal level gradient in the vicinity of the corresponding cell boundary signal level is obtained. Therefore, calculation of phase error based on this gradient information results in less accurate phase error information. Thus, in order to improve precision of PLL control, an operation is necessary for not detecting phase error information where the difference between the pit levels of two adjacent cells determined during reproduction is less than a predetermined level. For example, where the two pit levels, k−1, k, and corresponding reproduction signal levels V (k−1), V(k) have a relationship expressed as |V(k−1)−V(k)|≦3, processing for stopping detection of phase error information is necessary.

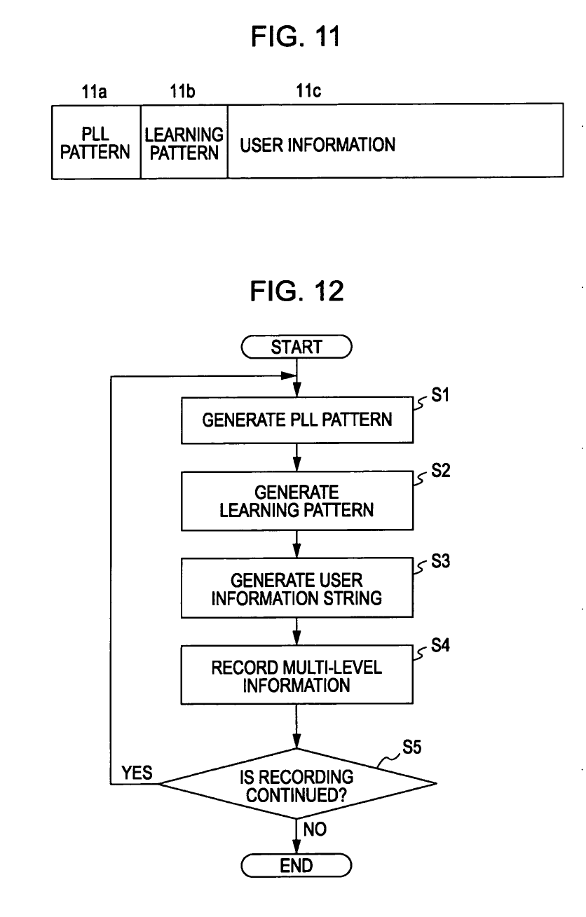

Referring now to FIG. 11, an actual operation procedure will be described, which is performed by the optical information recording/reproduction apparatus 1 using the phase error information detection method as described above. The figure illustrates recording information strings including a PLL pull-in pattern 11a, a learning pattern 11b, and user information 11c. The PLL pull-in pattern 11a is used for PLL pull-in and is employed in many circumstances regardless of whether or not multilevel recording is performed. The learning pattern 11b is used for a learning process for obtaining an ideal reproduction signal having a given pattern, as described above. The user information 11c is generated after undergoing processes such as error correction. Thus, according to the exemplary embodiment of the present invention, any pattern serving specifically for PLL control of a reproduction clock need not be inserted.

Referring now to FIG. 11 and FIG. 12, a recording operation procedure will be described. Upon receiving an instruction of information recording, the optical information recording/reproduction apparatus 1 initiates a recording operation.

In the optical information recording/reproduction apparatus 1, the PLL pull-in pattern 11a is first generated for initiating the recording operation, at STEP S1.

It is desirable that the PLL pull-in pattern 11a has a configuration that provides a frequency and phase error information through known binarization processing, so that PLL processing can be performed. For example, irrelevantly to a multilevel recording information string, the PLL pull-in pattern 11a can be configured such that a cell which is filled with an information pit and a cell in which no pit exists are alternately recorded. Moreover, in order to obtain a reproduction signal with an increased S/N ratio, the PLL pull-in pattern can also be configured such that two adjacent pitted cells and two adjacent non-pitted cells are alternately arranged. In addition, these configurations can be combined to form a pattern.

Subsequently, at STEP S2, the learning pattern 11b for a multilevel information string is generated and then appended at the position immediately after the PLL pull-in pattern 11a, as shown in FIG. 11.

Taking into account the pit level combination patterns of two adjacent cells, it is necessary that this learning pattern 11b includes at least 64 (8×8) patterns.

Then, transmitted information to be recorded is converted into eight levels in units of three bits as shown in FIG. 2. At this time, processing such as modulation and addition of an error correction code is carried out. Thus, the user information string 11c is generated as a string for information recording and appended to those patterns described above, at STEP S3.

When the generated recording information string is received, multilevel information is recorded on a target track of the optical disc 4 through the optical head 5 using a recording pulse string corresponding to each of the multiple levels, at STEP S4.

The above procedure from STEP S1 to STEP S4 is repeated as long as recording information to be recorded remains, at STEP S5. When all recording information is recorded, the optical information recording/reproduction apparatus 1 terminates the recording operation procedure.

In regard to address information or the like in a disc, recently, a technique has been widely employed in which address information is formed by wobbling a pregroove on an information recording track, and the address information is extracted by reproducing the signal from the wobbled pregroove. With this technique, it is not necessary to add address information directly to a recording information string or the like.

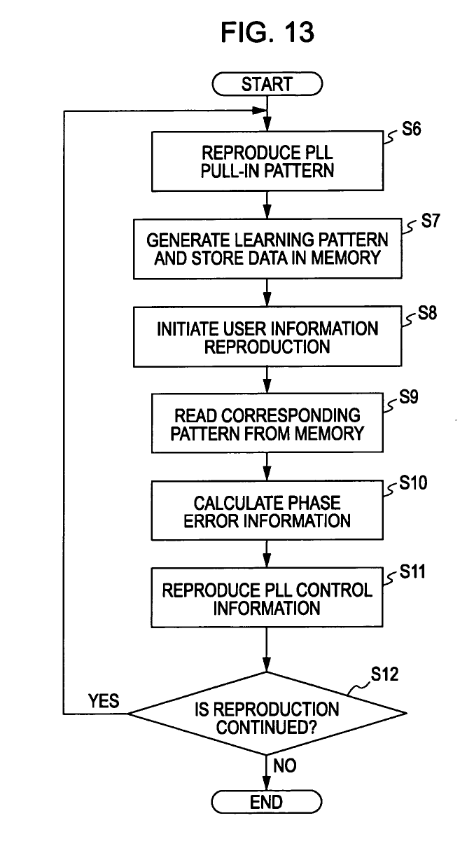

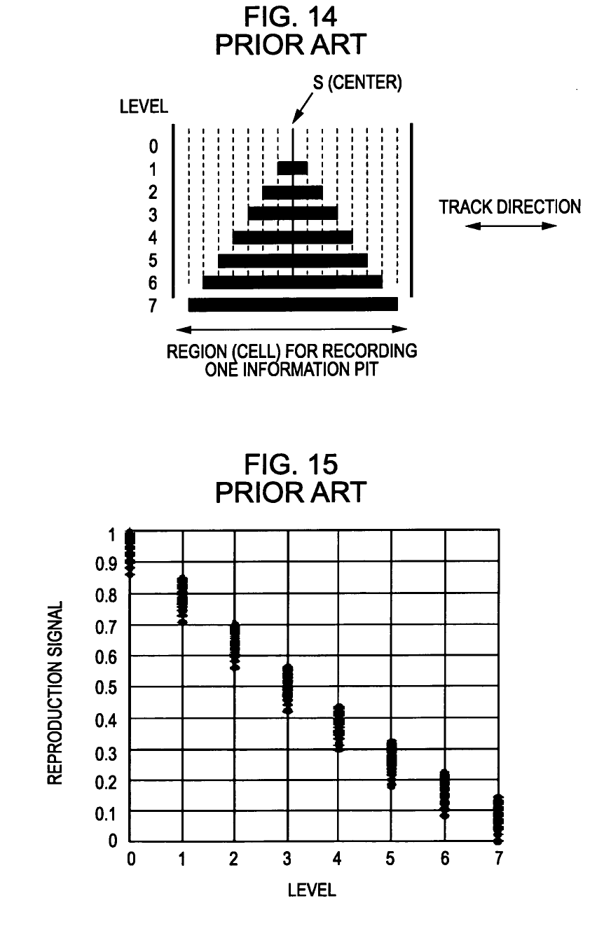

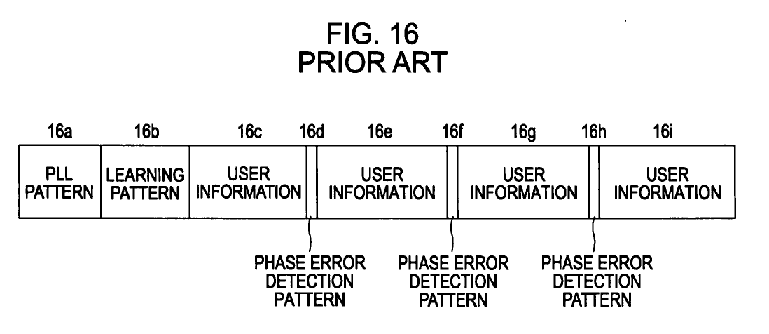

Now, an operation procedure for reproducing multilevel information recorded through the above recording procedure will be described with reference to FIG. 13.

Upon receiving an instruction of information reproduction, the optical information recording/reproduction apparatus 1 initiates a reproduction operation.

In the optical information recording/reproduction apparatus 1, address information is reproduced using wobble information or the like, as described above, and a target track on the optical disc 4 is searched. Using the optical head 5, reproduction of the PLL pull-in pattern 11a provided at the head of the information recording strings is initiated, and a reproduction clock synchronized with the width of a cell is generated, at STEP S6.

Then, using the reproduction clock, the learning pattern 11b is reproduced, and reproduction signal levels (cell center signal level, cell boundary signal level) corresponding to the recorded patterns are sampled and stored in a memory in correspondence with the recorded patterns, at STEP S7.

At this time the reproduction clock in this case can be held synchronized with the reproduction signal by the PLL pull-in pattern 11a. Thus, phase control of the reproduction clock is not necessary. In this operation, after the PLL pull-in pattern 11a is reproduced, phase error information is set to “0”, and thus a PLL state is maintained, so that sufficient phase precision can be achieved.

On the basis of the result obtained from the above learning process, reproduction of the recorded user information 11c is carried out using a reproduction signal, at STEP S8. Since a scheme used for reproducing user information is not directly relevant to the essence of this exemplary embodiment, a detailed description thereof will be omitted.

At this time, it is important to control the reproduction clock so that it is maintained to be synchronized with the reproduction signal in order to reproduce information with precision. Therefore, as described above, obtaining information on a phase error between the reproduction clock and the reproduction signal is necessary.

Thus, the pit levels of information pits written in two adjacent cells sequentially reproduced in STEP S8 are determined. Then, from the determined pit levels, corresponding ideal cell center signal levels and the cell boundary signal level therebetween, which are obtained from the learning process and stored in the memory, are extracted and read, at STEP S9.

Using the change in the read two cell center signal levels and the cell boundary signal level therebetween, a reproduction signal level gradient curve in the vicinity of the cell boundary signal level in the ideal state is calculated. Then, this reproduction signal level gradient curve and cell boundary signal level obtained in the learning process, and the cell boundary signal level of an actual reproduction signal obtained from the sampling process are used to calculate information on phase error between the reproduction clock and the reproduction signal obtained during reproduction, at STEP S10.

As described above, when the difference between the. pit levels of the adjacent cells is smaller than a predetermined level, processing for temporarily discontinuing the phase error detection can also be performed in this reproduction operation procedure.

On the basis of the obtained phase error information, PLL control is performed and thus the reproduction clock is generated, at STEP S11. A PLL circuit used for this PLL control is not required to have a special configuration and its characteristics can be optimized in accordance with a frequency band of the reproduction signal. A description of this PLL circuit will be omitted.

While the information reproduction operation is in progress, the procedure from STEP S9 to STEP S11 is sequentially performed, so that phase error information is extracted from the reproduction signal and thus a synchronous clock is continuously generated.

In addition, the above operation procedure is repeated in units of the information recording strings 11a, 11b, and 11c, such that information reproduction is carried out, at STEP 12.

Upon receiving an instruction of the termination of the reproduction operation, the optical information recording/reproduction apparatus 1 terminates the reproduction operation procedure.

With the above reproduction operation procedure, information reproduction without adding a phase error information pattern can be achieved.

Note that phase error information can be utilized not only for the generation of a reproduction clock. A standard deviation of phase error information can also be used as an indicator which corresponds to jitter in binary reproduction, for example.

In addition, information necessary for phase error detection, such as ideal signal levels and gradient, can be calculated and stored in a memory in correspondence with changes in pit levels of adjacent cells before the optical information recording/reproduction apparatus 1 is delivered to the market. Then, on the basis of this stored information, and cell center signal levels and a cell boundary signal level detected when information is reproduced, phase error information can also be calculated.

Further, it is possible to tabulate phase error information in advance and extract the tabulated phase error information on the basis of an ideal cell boundary signal level and a detected cell boundary signal level.

In the foregoing, a method and an apparatus for performing recording or reproducing using three or more value levels of information pits are described. In the method and apparatus, phase error information for generating a reproduction clock can be obtained from a reproduction signal obtained through reproduction of recorded information, without a pattern specifically arranged for the generation of a reproduction clock.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-216226 filed on Jul. 26, 2005, which is hereby incorporated by reference herein in its entirety.

What is claimed is:

1. An optical information reproduction method in which virtual cells are provided at regular intervals on an optical information medium and in which multilevel information is reproduced from the optical information medium having a recording/reproduction area for, using a light spot, recording multilevel information by changing widths in a track direction or sizes of information pits in the virtual cells and reproducing multilevel information by detecting from the information pits multiple levels of a reproduction signal, the method comprising the steps of:
detecting, in at least two adjacent virtual cells in the recording/reproduction area, at least two cell center signal levels and a cell boundary signal level between the cell center signal levels; and
acquiring phase error information of the reproduction signal based on a difference between the detected cell boundary signal level and an ideal cell boundary signal level obtained in advance and on a gradient of reproduction signal levels corresponding to the detected cell center signal levels.

2. The optical information reproduction method of claim 1,
wherein the ideal cell boundary signal level and the gradient are obtained by reproducing a multilevel learning area having information pits for performing learning which are recorded on the head of the recording/reproduction area.

3. The optical information reproduction method of claim 2,
wherein the multilevel learning area comprises a plurality of patterns based on combinations of various signal levels.

4. The optical information reproduction method of claim 1,
wherein the ideal cell boundary signal level and the gradient are obtained by a simulation.

5. The optical information reproduction method of claim 1,
wherein the gradient is obtained by linear approximation between two cell center signal levels having the ideal cell boundary signal level therebetween.

6. The optical information reproduction method of claim 1,
wherein the phase error information to be acquired is tabulated in advance and extracted based on the ideal cell boundary signal level and the detected cell boundary signal level.

7. The optical information reproduction method of claim 1,
wherein a difference between the two cell center signal levels is at least a predetermined minimum value.

8. An optical information recording/reproduction apparatus comprising:
an information recording circuit for, using a light spot, recording multilevel information on virtual cells provided at regular intervals on an optical information medium having a recording/reproduction area by changing widths in a track direction or sizes of information pits; and
an information reproduction circuit for reproducing multilevel information by detecting multiple levels of a reproduction signal from the information pits recorded on the optical information medium,
wherein the information reproduction circuit detects, in at least two adjacent virtual cells, at least two cell center signal levels and a cell boundary signal level between the cell center signal levels, and acquires phase error information of the reproduction signal based on a difference between the detected cell boundary signal level and an ideal cell boundary signal level corresponding to the detected cell center signal levels and on a gradient of reproduction signal levels in the vicinity of the ideal cell boundary signal level.

9. The optical information recording/reproduction apparatus of claim 8,
wherein the ideal cell boundary signal level and the gradient are obtained by reproducing a multilevel learning area having information pits for performing learning which are recorded on the head of the recording/reproduction area.

10. The optical information recording/reproduction apparatus of claim 9,
wherein the multilevel learning area comprises a plurality of patterns based on combinations of various signal levels.

11. The optical information recording/reproduction apparatus of claim 8,
wherein the ideal cell boundary signal level and the gradient are obtained by a simulation.

12. The optical information recording/reproduction apparatus of claim 8,
wherein the gradient is obtained by linear approximation between two cell center signal levels having the ideal cell boundary signal level therebetween.

13. The optical information recording/reproduction apparatus of claim 8,
wherein the phase error information to be acquired is tabulated in advance and extracted based on the ideal cell boundary signal level and the detected cell boundary signal level.

14. The optical information recording/reproduction apparatus of claim 8,
wherein the difference between the two cell center signal levels is at least a predetermined minimum value.

15. An optical information recording/reproduction apparatus comprising:
information recording means for recording multilevel information on virtual cells provided at regular intervals on an optical information medium using a light spot by changing widths in a track direction or sizes of information pits; and
information reproduction means for reproducing multilevel information by detecting multiple levels of a reproduction signal from the information pits recorded on the optical information medium,
wherein the information reproduction means detects, in at least two adjacent virtual cells, at least two cell center signal levels and a cell boundary signal level between the cell center signal levels, and acquires phase error information of the reproduction signal based on a difference between the detected cell boundary signal level and an ideal cell boundary signal level corresponding to the detected cell center signal levels and on a gradient of reproduction signal levels in the vicinity of the ideal cell boundary signal level.
